(19) United States
(12) Patent Application Publication
(10) Pub. No.: US 2003/0063349 A1
(43) Pub. Date: Apr. 3, 2003

(54) Dispersion compensation in agile networks

(76) Inventors: Bram Peeters, Harlow (GB); Duncan J. Forbes, Bishops Stortford (GB)

Correspondence Address: William M. Lee, Jr., Lee, Mann, Smith, McWilliams, Sweeney & Ohlson, Suite 410, 209 South LsSalle Street, Chicago, IL, 60604-1202, US

(21) Appl. No.: 09/966,866

(22) Filed: Sep. 28, 2001

(51) Int. Cl. H04B 10/00; H04B 10/12

(52) U.S. Cl. 359/161; 359/173

(57) ABSTRACT

An optical link 1 from one terminal A to another B has a series of spans 2 interconnecting nodes between the terminals A, B. Dispersion compensation means applies dispersion compensation to each span 2. Each span 2 contributes noise and the total noise in the link is result of the contributions from each span 2. The spans 2 may be normalised and the total noise in the link the sum of the contributions from each span. The amount of dispersion compensation applied to each span 2 by the dispersion compensation means is determined in accordance with the noise contribution of that span 2.

### FIELD OF THE INVENTION

The invention relates to dispersion compensation in optical communications networks, in particular in agile optical communications networks.

### BACKGROUND OF THE INVENTION

In typical optical communications networks, optical fibres carry modulated optical signals on a link between terminals. The link generally comprises a series of optical fibre spans interconnecting nodes between the two terminals. Chromatic dispersion is an inherent property of transmission through optical fibres. In optical communications network links, chromatic dispersion can have the effect of distorting the signal as it is carried along. To overcome such effects, dispersion compensation modules (DCMs) are included, generally, at each of the nodes in the network. A DCM may consist of dispersion compensating optical fibre whose dispersion value is such as to counteract the dispersion value of the an adjacently connected span. Dispersion and Slope Compensating Modules (DSCMs) may also be included which compensate for slope as well as dispersion at a single wavelength. Hereinafter the terms dispersion compensation and dispersion and slope compensation (and corresponding abbreviations) should be understood as interchangeable.

In agile optical communications networks, the arrangement of nodes and spans is such that various different links between two terminals may be viable. That is to say, an optical signal may follow any one of a number of different paths between the terminals. By normalising each span, that is to say, by controlling the net gain in each span to 0 dB, each span can be linked to any other span without concerns about changes in power levels between cross-connections. 0 dB net gain is achieved by amplifying the signal in a span, usually by means of an amplifier at an adjacent node, so as to offset losses encountered as a result of such factors as imperfect coupling of the signal into the span, and absorption and scattering effects in the span either as a result of inherent characteristics of the fibres or introduced characteristics such as splices etc..

The viability of a link may be defined in terms of the acceptable signal to noise ratio (OSNR) of a signal on reaching the receiver terminal together, with a distortion penalty which may be attributed to dispersion, non-linear effects, crosstalk etc. The acceptable quality of any link is related to the permissible bit error rate of signals at the receiver terminal. The acceptable quality value in any link may be expressed in terms of the Q value. In a normalised link, noise is a linearly cumulative effect and the total noise in any link is the sum of the noise contributions from each of the spans. Noise in any span is related to the losses in that span. Each of the various spans in an agile network may have a different loss value, with some less lossy than others. However, any terminal-to-terminal link will be viable so long as the sum total of the noise contributions from each span does not exceed the allowed maximum as defined by the acceptable OSNR at the receiver terminal.

The distortion penalty will be characterised by an optimum dispersion strategy for the link. In conventional long-haul systems optimised to maximise reach and capacity the power levels will be high enough to cause non-linear interactions within the fibre. The fibre dispersion will interact with these non-linear effects, such that the dispersion strategy and DCM placement is optimised to minimise non-linear penalties. The requirement for agility in networks has led to the use of reduced optical powers such that non-linear effects no longer introduce significant penalties when interacting with dispersion.

There have been proposals for applying optimum dispersion compensation to links in agile communications networks.

A first proposal was that a per-span dispersion compensation value should be calculated on the basis of the maximum number of the lossiest spans which are allowed to constitute a link according to the maximum allowable noise. That is to say, if the maximum allowable noise in a link dictates that the link can comprise at the most x of the lossiest spans, then the per-span compensation value is calculated at 1/x of the optimum total dispersion. Hence, every span in the network is compensated at the per-span compensation value. However, in the event that a signal is carried on a link which comprises a series of span each of which is less lossy than the lossiest, and hence the link will have more than x spans, then the signal will be excessively dispersion compensated.

A second proposal was to compensate every span to a zero net dispersion. In other words, at each pre or post node, a dispersion compensation module may be provided so as to completely offset the dispersion in any span. Whilst such a proposal is ideally suited to agile communications networks, realigning each of the signals carried by the span at its end can result in undesirable non-linear effects.

Short spans offer the potential of a reduced noise contribution to any link. Therefore, the possibility of a link comprising more short spans is desirable.

### OBJECT OF THE INVENTION

An object of the invention is to provide a manner of dispersion compensation adapted for agile networks.

### BRIEF DESCRIPTION OF THE INVENTION

According to a first aspect, the invention provides an optical link from one terminal to another comprising a series of normalised spans interconnecting nodes between the terminals, dispersion compensation means applying dispersion compensation to each span, wherein each span contributes noise and the total noise in the link is the sum of the contributions from each span and wherein the amount of dispersion compensation applied to each span by the dispersion compensation means is determined in accordance with the noise contribution of that span.

In a link according to the invention the desired optimum dispersion compensation is achieved over the whole length of the link. Thus, there may be net over- or under-compensation in each span with the over- or under-compensations balancing out over the length of the link, or a net over- or under-effect at the end of the link if such is desired. Net over- or under-compensation in any span may have a penalising effect on the signal quality within that span. However, so long as the penalising effect is not such as to cause the cumulative penalty along the link to exceed the permissible maximum, the residual or excess dispersion is acceptable. In other words, there are multiple parameters, noise and dispersion and the Q value which is a function of both of these, to take into account in each span and optimising the multiple parameters jointly facilitates maximum agility for the link and consequently the network of which it may form part.

Preferably, a maximum allowable noise is defined for the link and the sum of the noise contributions from each span is less than the maximum allowable noise.

Residual or excess dispersion in any span may reduce the acceptable quality for the link and the number of spans is further preferably such that the quality is not reduced below an acceptable level.

The dispersion compensation applied to each span by the dispersion means may be determined in accordance with the noise contribution of that span in relation to the maximum allowable noise.

Also further preferably, the link has an optimum dispersion compensation value.

The dispersion compensation applied to each span by the dispersion compensation means may equal:

$$\frac{\text{Span noise contribution}}{\text{Maximum allowable noise}} \times \text{Optimum dispersion compensation}$$

The dispersion compensation means may comprise a dispersion compensation module for each span. A dispersion compensation module may comprise at least one of: dispersion compensating optical fibre, fibre grating, virtually imaged phase array, MEMS etalon, cascaded Mach Zehnder or any mechanism which compensates for fibre dispersion. A dispersion compensation module may be located at a node so as to pre- or post-compensate an adjacent span.

The invention may further comprise amplification means normalising each span. The amplification means may comprise a series of optical amplifiers. An optical amplifier may be located at a node so as to pre- or post-amplify a signal in an adjacent span.

According to a second aspect the invention provides dispersion compensation means for applying dispersion compensation to one of the spans in a link from one terminal to another, having a series of normalised spans interconnecting nodes between the terminals, wherein the span contributes noise and the total noise in the link is the sum of the contribution from each of the spans, the dispersion compensation means applying to each span an amount of dispersion compensation determined in accordance with the noise contribution of that span.

According to a third aspect, the invention provides one of the spans in a link from one terminal to another, having a series of normalised spans interconnecting nodes between the terminals, wherein the spans contribute noise and the total noise in the link is the sum of the contributions from each of the spans, the said one span having applied thereto an amount of dispersion compensation determined in accordance with the noise contribution of that span.

According to a fourth aspect, the invention provides an optical communications network comprising a link according to a first aspect of the invention, dispersion compensation means according to a second aspect of the invention or a span according to a third aspect of the invention.

According to a fifth aspect, the invention provides a node in an optical communications link comprising dispersion compensation means according to a second aspect of the invention.

According to a sixth aspect, the invention provides an optical link from one terminal to another comprising a series of spans interconnecting nodes between the terminals, dispersion compensation means applying dispersion compensation to each span, wherein each span contributes noise and the total noise in the link is the result of the contributions from each span and wherein the amount of dispersion compensation applied to each span by the dispersion compensation means is determined in accordance with the noise contribution of that span.

According to a seventh aspect, the invention provides a method of dispersion compensation in a link from one terminal to another, having a series of normalised spans interconnecting nodes between the terminals, wherein each span contributes noise and the total noise in the link is the sum of the contributions from each span, the method comprising applying dispersion compensation to each span in accordance with the noise contribution of that span.

According to an eighth aspect, the invention provides a method of dispersion compensation in a link from one terminal to another, having a series of spans interconnecting nodes between the terminals, wherein each span contributes noise and the total noise in the link is the result of the contributions from each span, the method comprising applying dispersion compensation to each span in accordance with the noise contribution of that span.

### BRIEF DESCRIPTION OF THE DRAWINGS

FIG. 1 is a schematic diagram of an optical communications link according to the invention; and

FIG. 2 are graphical illustrations of the noise and dispersion behaviours of the paths shown in FIG. 1.

### DESCRIPTION OF THE INVENTION

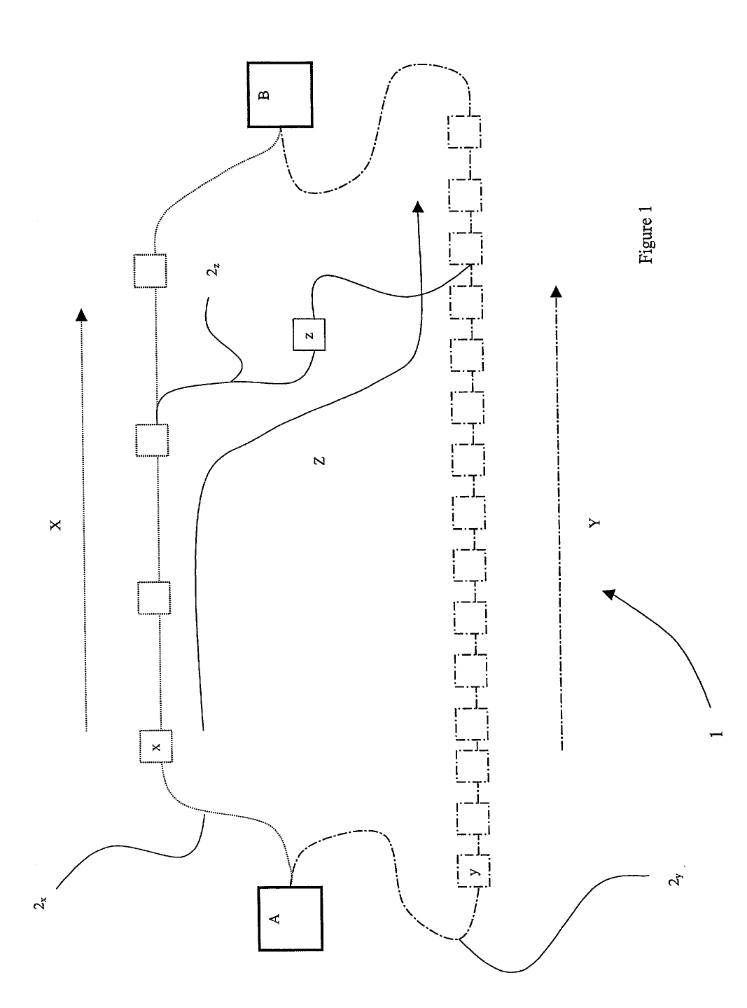

With reference to FIG. 1, an optical communications network 1 extends from terminal A to terminal B. Terminal A is a telephone exchange in a first town and terminal B is a telephone exchange in a second town. Between the terminals A and B are a network of nodes x (dotted lines), y (dashed and dotted lines), z (solid line) interconnected by optical fibres spans 2. Each of the nodes x, y, z is at a town or other geographical location intermediate the terminals A and B. At the nodes there are signal processing equipment (not shown) such as receivers, transmitters, amplifiers and dispersion compensation modules. For the purpose of illustration of the invention, the network 1 will be considered in the context of unidirectional transmission from a transmitter at terminal A to a receiver at terminal B.

Each of the spans 2 is normalised and the net gain in each span is OdB. Pre- and post-optical fibre amplifiers (not shown) at the nodes x, y, z amplify the signals in the adjacent spans 2 so as to offset the losses encountered in those spans as a result of such factors as coupling of signals into the spans 2, and absorption and scattering effects in the spans 2. The amount of noise in any span 2 is related to the losses in that span 2. As each of the spans is normalised, the total noise in the link from terminals A to B is the linear sum of the individual noise contributions from each of the spans 2, and for a link 1 to be viable the noise at any point along the link 1 must not exceed the maximum allowable noise and the OSNR at terminal B must be less than the maximum allowable.

The network 1 has spans 2 of various different loss values. The nodes x are interconnected with one another and with points A and B by spans 2ₓ (dotted lines) of relatively high loss. The nodes y are interconnected with one another and points A and B by spans 2_{y} (dashed and dotted lines) of relatively low loss. The node z is connected to one node x and to one node y respectively by spans 2_{z} (solid lines) of relatively moderate loss. The maximum allowed noise between terminals A and B, or rather the acceptable OSNR at terminal B as dictated by the acceptable bit error rate at terminal B, is such that any of the following links between terminals A and B is viable: link X, link Y or link Z. In other words, the maximum allowable noise in the link between terminals A and B is not exceeded by the noise contributions from five high loss spans 2ₓ in series; sixteen low loss spans 2_{y} in series; or three high loss spans 2ₓ in series with two moderate loss spans 2_{y}. in series with three low loss spans 2_{y}.

There is also an optimum dispersion compensation value for compensating against chromatic dispersion for any optical signal transmitted between terminals A and B. Each span 2 is provided with dispersion compensation means in the form of a pre- or post-dispersion compensation module (not shown) comprising a length of dispersion compensating fibre at a node x, y, z adjacent the span 2. Each dispersion compensating fibre applies dispersion compensation to the corresponding span. The value of the applied dispersion compensation is calculated according to the noise contribution of the corresponding span 2 in relation to the maximum allowable noise for the link 1. That is to say, the value applied by the dispersion compensation module to a span 2 is equivalent in percentage terms to the noise contribution of that span as a percentage of the maximum allowable noise in the link 1. This could be otherwise expressed as:

$$\frac{\text{Span noise contribution}}{\text{Maximum allowable noise}} \times \text{Optimum dispersion compensation}$$

Thus, in the case of link X, the noise contribution from each span 2ₓ equates to 20% of the maximum allowable noise in the link I from A to B, and the dispersion compensation means for each span in link X will apply 20% of the optimum dispersion compensation value. In the case of link Y there are sixteen spans 2_{y} and the contribution of each span 2_{y} is 6% of the maximum allowable noise. Thus, the dispersion compensation means for each span 2_{y} in link Y applies 6% of the optimum dispersion compensation value. In the case of link Z, the noise contribution from each of the spans 2_{z} equates to 8% of the maximum allowable noise. Thus, a signal following link Z will be subjected by the dispersion compensation means associated with the three spans 2ₓ to 20% of the optimum compensation value: the dispersion compensation means associated with spans 2_{z} will apply 8% of the dispersion compensation value and the three spans 2_{y} will apply 6% of the dispersion compensation value.

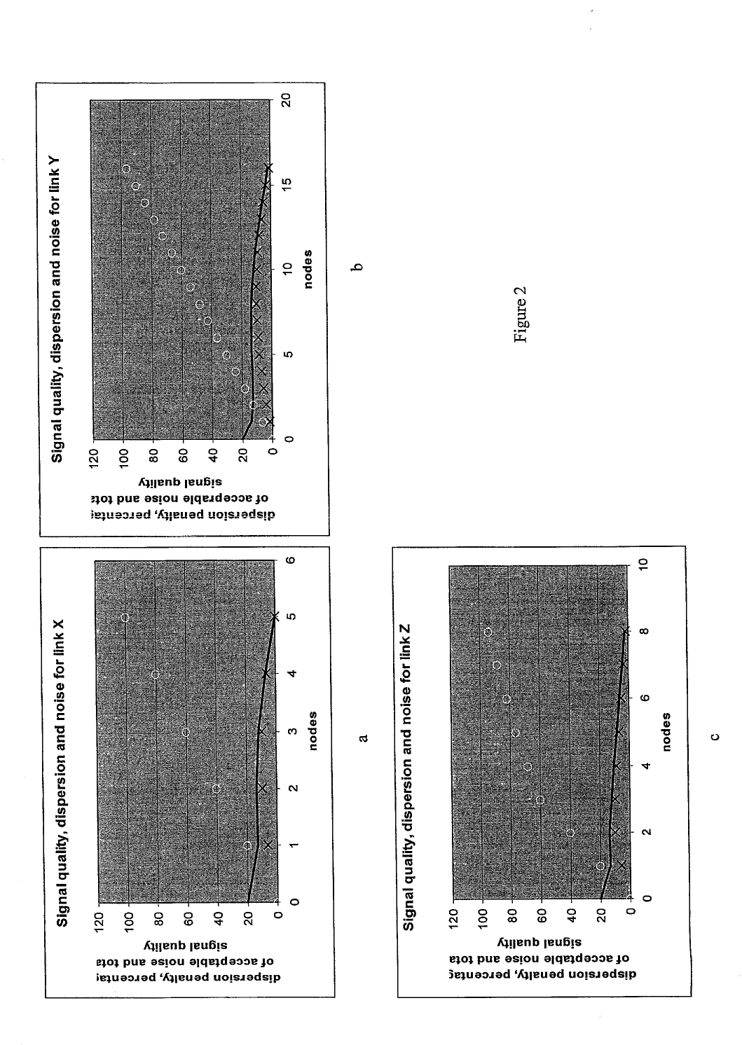

With reference to FIG. 2, each of the graphs a, b, c illustrates the noise characteristics for the links X, Y and Z shown in FIG. 1 respectively. Each graph shows (white circles) the noise at any point along the link in relation to the maximum allowed OSNR at the end of the link (100%); the penalty on noise in dBs as a result of the dispersion compensation applied to each span along the link (black crosses); and the resultant signal quality in dBs as a result of the penalising effect of the dispersion compensation (black line). As will be seen, the resultant relative signal quality is never such that it drops below 0 dB, confirming that each path is viable. Hence, the graphs illustrate how the multiple parameters of noise and dispersion can be optimised within the acceptable limits of a link so as to provide agility, that is, a variety of different possible paths to constitute a link.

1. An optical link from one terminal to another comprising a series of normalised spans interconnecting nodes between the terminals, dispersion compensation means applying dispersion compensation to each span, wherein each span contributes noise and the total noise in the link is the sum of the contributions from each span and wherein the amount of dispersion compensation applied to each span by the dispersion compensation means is determined in accordance with the noise contribution of that span.

2. An optical link according to claim 1 wherein a maximum allowable noise is defined for the link and the sum of the noise contributions from each span is less than the maximum allowable noise.

3. An optical link according to claim 2 wherein residual or excess dispersion in any span reduces the acceptable noise for the link and the number of spans is such that the sum of the noise contributions does not exceed the maximum allowable noise.

4. An optical link according to claim 2 wherein the dispersion compensation applied to each span by the dispersion means is determined in accordance with the noise contribution of that span in relation to the maximum allowable noise.

5. An optical link according to any claim 1 wherein the link has an optimum dispersion compensation value.

6. An optical link according to claim 5 wherein the dispersion compensation applied to each span equals:
Span noise contribution/Maximum allowable noise×Optimum dispersion compensation

7. An optical link according to claim 1 wherein the dispersion compensation means comprises a series of dispersion compensation modules.

8. An optical link according to claim 7 wherein a dispersion compensation module is located at a node so as to pre- or post-compensate an adjacent span.

9. An optical link according to any claim 1 further comprising amplification means normalising each span.

10. An optical link according to claim 9 wherein the amplification means comprises a series of optical amplifiers.

11. An optical link according to claim 10 wherein an optical amplifier is located at a node so pre- or post-amplify a signal in an adjacent span.

12. An optical link according to claim 1 wherein the series of spans are not normalised and the total noise in the link is the result of the contributions from each span.

13. Dispersion compensation means for applying dispersion compensation a span in an optical link from one terminal to another, having a series of normalised spans interconnecting nodes between the terminals, wherein each span contributes noise and the total noise in the link is the sum of the contribution from each of the spans, the dispersion compensation means applying to each span dispersion compensation determined in accordance with the noise contribution of that span.

14. Dispersion compensation means according to claim 13 comprising a series of dispersion compensating modules.

15. Dispersion compensation means according to claim 14 wherein a dispersion compensation module is located at a node so as to pre- or post-compensate an adjacent span.

16. Dispersion compensating means according to claim 14 wherein each span is an optical fibre span and each dispersion compensation module comprises at least one of: dispersion compensating optical fibre, fibre grating, virtually imaged phase array, MEMS etalon, cascaded Mach Zehnder.

17. A span in a link from one terminal to another, having a series of normalised spans interconnecting nodes between the terminals, wherein the spans contribute noise and the total noise in the link is the sum of the contributions from each of the spans, the said span having applied thereto dispersion compensation determined in accordance with the noise contribution of that span.

18. An optical communications network comprising a link according to claim 1

19. An optical communications network comprising dispersion compensation means according to claim 13.

20. An optical communications network comprising a span according to claim 17.

21. A node in an optical communications link comprising dispersion compensation means according to claim 13 .

22. A method of dispersion compensation in a link from one terminal to another, having a series of normalised spans interconnecting nodes between the terminals, wherein each span contributes noise and the total noise in the link is the sum of the contributions from each span, the method comprising applying dispersion compensation to each span in accordance with the noise contribution of that span.

23. A method according to claim 22 wherein the series of spans are not normalised and the total noise in the link is the result of the contributions from each span.

24. An optical fibre link from a transmitter to a receiver comprising a series of normalised optical fibre spans interconnecting nodes between the transmitter and the receiver, a dispersion compensation module at each node applying dispersion compensation to an adjacent span, wherein each span contributes noise and the total noise in the link is the sum of the contributions from each span and wherein the amount of dispersion compensation applied to a span by a module is determined in accordance with the noise contribution of that span.
